(19) United States
(12) Patent Application Publication
(10) Pub. No.: US 2014/0283392 A1
(43) Pub. Date: Sep. 25, 2014

(54) Motorized Shears with Adjustable Blade Separation

(71) Applicant: HYDROGARDEN INDUSTRY INNOVATIONS, INC., Castro Valley, CA (US)

(72) Inventor: Joshua Mezher, Santa Cruz, CA (US)

(21) Appl. No.: 13/847,448

(22) Filed: Mar. 19, 2013

(51) Int. Cl. A01G 3/037

(52) U.S. Cl. CPC A01G 3/037
USPC 30/228

(57) ABSTRACT

A motorized shears with adjustable blade separation unit includes a housing and a motor coupled to a moving blade gear which drives a moving blade. A battery case body contains a battery pack and a means by which to charge the battery pack through an electrical outlet. The unit can be placed in automatic mode or semi-automatic mode by actuating a mode switch. When the unit is in semi-automatic mode the user can tap a touch sensor to activate blade movement. When the unit is in automatic mode environmental factors will determine the speed at which the moving blade moves. In some embodiments the touch sensor may be a touch screen which relays information from the unit and allows the user to change a variety of settings.

### BACKGROUND

1. Field of Invention

The current disclosure relates to a device and method used mainly for gardening work such as trimming of plants and hedges as well as pruning roadside trees and more particularly to a device and method of adjusting blade separation.

2. Background

The current state of gardening and farming technology encompasses a wide range of tools. In the case of trimming hedges, roadside trees, and stem removal during harvest season for various crops there are small hand trimmers or micro shears which are designed to be used in small scale operations. When these manual devices used for large projects time is wasted and the user often suffers from medical problems involving repetitive strain injuries.

There are also much larger and costlier products designed to serve large scale gardening or production needs. Only extremely large scale projects warrant the expense involved in the purchase and maintenance of such products.

What is needed is a device that fills the niche in between the two kinds of products listed above. This device is one that can be hand-held, but be designed in a way that scales more easily to larger production than conventional micro shears. The present disclosure relates a motorized device with an adjustable blade which will increase efficiency while protecting the health of the user by preventing repetitive strain injuries.

### BRIEF DESCRIPTION OF THE DRAWINGS

FIG. 1 is a view of one embodiment of a Motorized Shears with Adjustable Blade

Separation.

FIG. 2 is a top down view of one embodiment of a Motorized Shears with

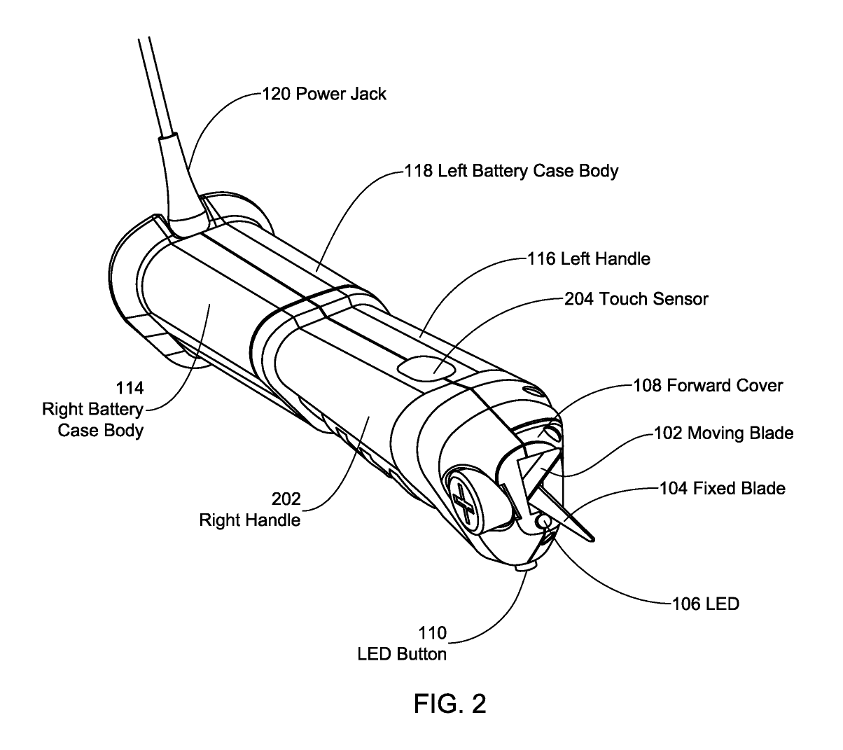

Adjustable Blade Separation.

FIG. 3 is a view of the Motorized Shears with Adjustable Blade Separation with the housing removed.

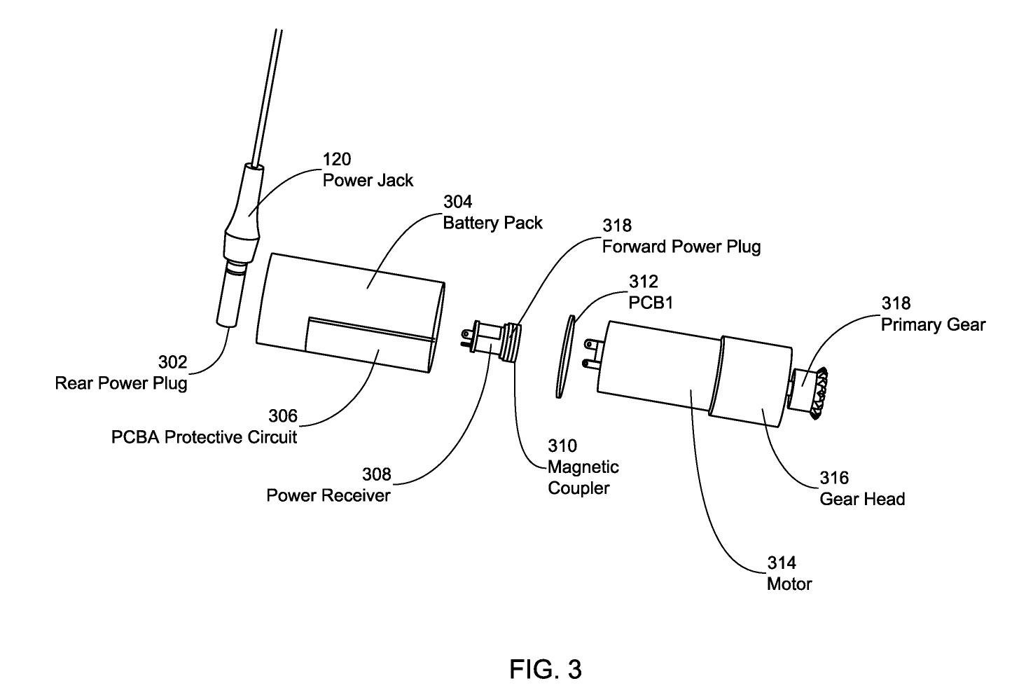

FIG. 4 is a view of the Motorized Shears with Adjustable Blade Separation with the housing removed and emphasis placed on the adjustable blade device and method.

### DETAILED DESCRIPTION

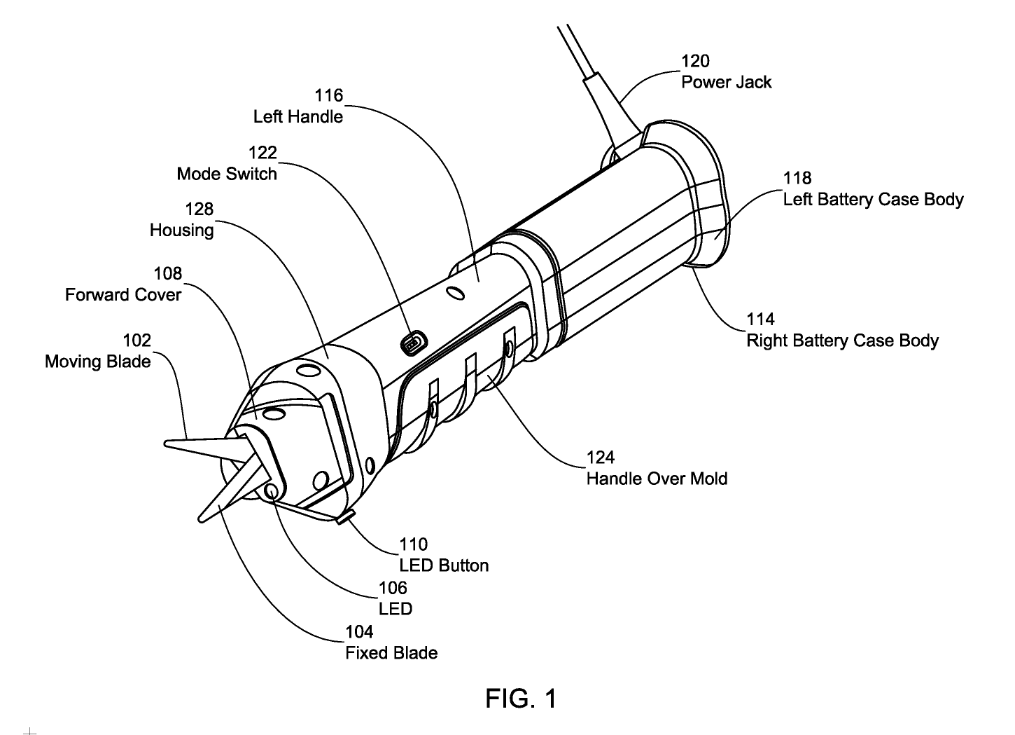

With initial reference to FIG. 1, an exemplary Motorized Shears with Adjustable Blade Separation (“Shears”) constructed in accordance with present day teachings is shown and generally identified at reference numeral 100. The Shears 100 may include a housing 128 having a forward cover 108, a left handle 116, a right handle 202, and a battery case body 114, 118. The general exterior can be made from a variety of plastics and metals as well as any other material that is known, useful, or desirable. The Shears 100 depicted in FIG. 1 can be shaped in any manner that benefits the user, however, the embodiment shown is an idealized version uniquely adapted to reduce physical stresses to the human body. Also, the handle overmold 124 in additional the overall shape of the Shears 100 has been designed in a way that may allow a user to hold the Shears 100 for long periods of time with reduced physical stress.

In general, the housing 128 covers the motor 314, gear head 316, sensor array 412, and a portion of the blades 102, 104. The battery case body 114, 118 covers a rear power plug 302, battery pack 304, and a PCBA protective circuit 306. Attached to the battery case body 114, 118 is a power jack 120. The housing 128 and internal components can be held together using several self-tapping screws, adhesive, or any combination of the two or alternatively any other material that is known, useful, or desirable.

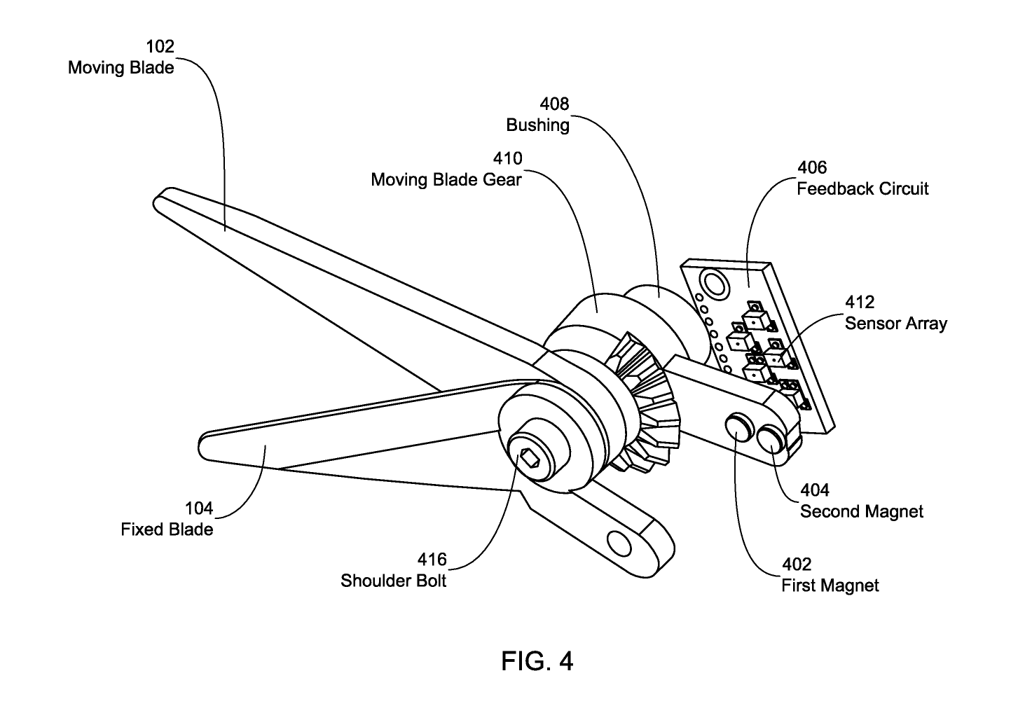

FIG. 4 depicts one embodiment of the adjustable blade systems which can be comprised of a moving blade 102, a fixed blade, 104, a first magnet 402, a second magnet 404, feedback circuit 406, bushing 408, moving blade gear 410, sensor array 412 comprising more than one magnet, primary gear 318, and a shoulder bolt 416. Some embodiments of the adjustable blade system will comprise additional or different components. The system can be driven by a primary gear 318 which drives the moving blade gear 410 and thereby causes the moving blade to oscillate 102. Objects are then severed when the moving blade 102 creates pressure between it and the fixed blade 104. In some embodiments both blades may move to create the force required to cut objects such as stems, leafs, branches, or anything else suitable for cutting. Also, depending on the application, blades of different length, shape, thickness, or material can be used. For example, some embodiments may use curved blades, blades that are partially or wholly serrated or metal blades with a Teflon coating.

In the embodiment depicted in FIG. 4 the moving blade 102 can be adjusted to create a larger or smaller opening between the two blades to accommodate different sized objects. Detection of the moving blade 102 position occurs through interaction between two magnets 402, 404 affixed to the moving blade gear 410 and a sensor array 412 laying on top of a feedback circuit 406. The feedback circuit 406 can convey this information to a motor which can then alter the position of the blades either automatically or according to the user's demands. The user can adjust the blade positioning via the touch sensor 204 located on the housing 128. Different embodiments may use additional magnets or magnets with different physical qualities such as size and shape depending on the specified application. Alternate embodiments may allow for the user to interface with the unit in any manner that is known, useful, or desirable. In some embodiments the touch sensor may operate as a touch screen which may provide visual information to the user as well as a means of interfacing with the Shears 100.

The blade movement will be driven by a motor 314 which will transfer power through a gear head 316. In the present embodiment, electricity will be delivered from a battery pack 304 or from a power jack 120 which can plug into wall electrical outlets. The electric power unit comprises a power jack 120, power plug 302, battery pack 304, a PCBA protective circuit 306, forward power plug 318, power receiver 308, and a magnetic coupler 310. As previously mentioned, a battery case body 118, 114 will cover the battery pack 304 as well as the parts listed above. In the present embodiment the power receiver 308 delivers power to the motor 314 and has an intermediary PCB 1 312. A magnetic coupler 310 may be used to couple the electric power unit to the rest of the Shears 100 unit. However, other embodiments may use another couplings means such as a clipping device or coupling clip. Furthermore, the type of motor and power used may not be limited to electricity. The magnetic coupler 310 or coupling clip may be interposed between the housing 128 and the battery case body 118 or may be interposed between the power receiver 308 and the motor 314. Various other configurations may be used to couple the power supply to other components of the Shears 100.

Printed circuit boards (PCBs) 406, 306, 312 may be used as a way for the user to send and receive information to and from the individual components of the Shears 100 and information may be displayed on the touch sensor 204 which can be a touch screen in some embodiments or through LEDs or through any other device or system capable of displaying information.

As previously mentioned, the user will be able to control the blade separation as desired. The user will also be able to control the motor 314 using the touch sensor 204 which can increase or decrease the speed at which the blades open and close. The user will also be able to enable an automatic mode when toggling the mode switch 122 which will cause the Shears 100 to vary the blade movement speed in accordance to environmental parameters. One embodiment of semi-automatic mode can involve the user toggling of the mode switch 122 to semi-automatic mode which can then allow the user to activate the blades by tapping the touch sensor 204. Other embodiments may allow for blade activation through other means. Through the touch sensor 204 the user will be able to toggle the LED 106 located under the blades. Alternatively, the user may activate the LED 106 by pressing the LED button 110. In some embodiments more than one LED light may be used which can be used both for illumination as well as for indicators relating to the status of the Shears 100. The LED 106 can illuminate the trimming area which will reduce stress on the user's eyes. White light may be used during the day and green light may be used at night to prevent photosensitive plants from being placed into a state of shock. Other LEDs can be used to indicate when the Shears 100 are in manual made, semi-automatic mode, and automatic mode. Another LED or set of LEDs can be used to indicate battery pack 304 level, blade separation, the condition of components, or any other state or condition of the Shears 100. In addition to the present invention the LED 106 depicted here can be incorporated into manual hand trimmers.

What is claimed:

1. A motorized shears, comprising:
a housing;
a motor coupled to said housing;
a primary gear mounted to said motor;
a moving blade;
a moving blade gear interposed between said primary gear and said moving blade;
a fixed blade; and
a shoulder bolt connecting said fixed blade, said moving blade, and said moving blade gear.

2. The motorized shears according to claim 1, further comprising:
a battery case body coupled to said housing;
a battery pack coupled to said battery case; and
a power receiver coupled to said battery pack,
said power receiver removably coupled to said motor.

3. The motorized shears according to claim 2, further comprising:
a magnetic coupler interposed between said housing and said battery case.

4. The motorized shears according to claim 2, further comprising
a coupling clip interposed between said housing and said battery case.

5. The motorized shears according to claim 1, further comprising:
at least one magnet coupled to said moving blade gear;
a feedback circuit coupled to said housing; and
a sensor array coupled to said feedback circuit and capable of interacting magnetically with said at least one magnet.

6. The motorized shears according to claim 5, further comprising:
a touch sensor coupled to said housing, said touch sensor is operably coupled to said motor.

7. The motorized shears according to claim 6, wherein said touch sensor is a touch screen with a graphical display.

8. The motorized shears according to claim 7, further comprising:
a mode switch coupled to said housing and operably coupled to said motor and wherein said touch sensor is movable between an automatic position and a semi-automatic position,
wherein, when said mode switch position is in the automatic position, said moving blade oscillates according to external environmental factors and when said mode switch position is in the semi-automatic position, said moving blade oscillates according to user input from said touch sensor.

9. The motorized shears according to claim 8, further comprising:
an LED coupled to said housing oriented below said fixed blade.

10. The motorized shears according to claim 1, further comprising:
an LED coupled to said housing oriented below said fixed blade.

11. The motorized shears according to claim 2, further comprising:
an LED coupled to said housing oriented below said fixed blade.

12. A method for shearing matter comprising a motor driving at least one blade.

13. The method of claim 12 further comprising at least one fixed blade.

14. The method of claim 13 further comprising at least one adjustable blade.

15. The method of claim 14 further comprising at least one touch screen controlling the separation between said at least one adjustable blade and said at least one fixed blade.
